(19) United States
(12) Patent Application Publication
(10) Pub. No.: US 2014/0222940 A1
(43) Pub. Date: Aug. 7, 2014

(54) Unified Communications Platform

(71) Applicants: Hakan Icuduygu, Ankara (TR); Hasan Gorgun, Ankara (TR)

(72) Inventors: Hakan Icuduygu, Ankara (TR); Hasan Gorgun, Ankara (TR)

(73) Assignee: Voksporta Teknoloji Ürünleri Sanayi ve Ticaret Anonim Sirketi, Ankara (TR)

(21) Appl. No.: 14/342,525

(22) PCT Filed: Sep. 2, 2011
(86) PCT No.: PCT/IB2011/053850

§ 371 Date: Mar. 3, 2014

(51) Int. Cl. H04L 29/06; H04M 11/06; H04L 12/58

(52) U.S. Cl. CPC H04L 65/1003; H04L 51/36; H04M 11/066; H04W 88/08
USPC 709/206

(57) ABSTRACT

The invention unified communications platform (1) utilizes different communication infrastructures such as PSTN, GSM, WLAN and interne and acts as a fully functional web server, mail server, IP PBX, VoIP server with embedded content management system to create personal web sites and is administrable through a single GUI. The invention unified communications platform (1) essentially comprises at least one telephone adapter (2), at least one mobile adapter (3), at least one network adapter (4), at least one DNS server (6), at least one mail server (7), at least one web server (8), at least one Vo IP server (9), at least one storage unit (10) and at least one processing unit (11).

### TECHNICAL FIELD

The present invention relates to a unified communications platform utilized in providing telecommunications services.

### BACKGROUND ART

The need for communication is as old as human history. People communicate using voices generated by the vocal chords and shape by the mouth, tongue and teeth when they are next to each other. People also utilized sign language to satisfy the communication needs of the ones who lack the ability to generate and/or hear vocal signals. Over time, the necessity of communicating over distances has arisen. In the beginning messages have been transferred using the smoke signals, light signals, and such. However these techniques strongly depended on having the communicating parties at sight. As the distance of the communicating parties increased, communication evolved into telecommunication. Telegraph lines and telephone lines formed the very first telecommunications infrastructure.

In modern times, the need for communication is so indispensably overwhelming that, the people who are taken apart from their mobile phones and internet start showing the symptoms of depression.

Today, our personal and business lives depend mostly on telecommunications. Corporations keep in touch with their customers by means of web sites, e-mails, telephone conversations, facsimiles and such. Other means of telecommunication are also being utilized. Most of telecommunication means operate over infrastructures like the GSM network, telephone network (PSTN), internet and such. For personal use, the advent of proprietary devices makes it easier to communicate. However when it comes to corporations, obstacles emerge. As the capacity demand of the corporations are higher, devices used for meeting the requirements become more complex. Furthermore, as the corporations need to utilize different infrastructures, technical knowledge required to keep the systems running and coordinated increases.

To reduce the complexity of the telecommunication systems, some integrated systems which can operate on different infrastructures are suggested. However, up to this point, no system capable of handling most of the communication means has been introduced.

As a recent addition to the communication spectrum, VoIP systems are introduced in order to reduce the cost of telecommunications. However the VoIP equipment needs to be set on a dedicated network in order to protect the network from attacks such as MITM attacks and maintain the quality of the VoIP service. Keeping the VoIP system separate may provide an extra layer of security, but sacrifices the simplicity and the cost effectiveness of the system. Also, integrated PBX and VoIP systems are highly vendor-specific, which means that in even the slightest problem, vendor has to be contacted. As the vendors are aware of this situation, they use their monopoly on the technical services and increase the cost of maintenance of the system.

A communications system comprising a PBX system with integrated FX channels for PSTN connection and GSM connectivity has been mentioned in the Chinese patent document CN101753741.

### BRIEF DESCRIPTION OF THE INVENTION

The main objective of the present invention is to achieve a unified communications platform that utilizes different communication infrastructures such as PSTN, GSM, WLAN and internet.

Another objective of the present invention is to achieve a unified communications platform that acts as a fully functional web server, mail server, DNS server, IP PBX, and VoIP gateway.

Another objective of the present invention is to create a unified communications platform that acts as a gateway which shares connections between clients.

Another objective of the present invention is to build a unified communications platform that is administrable through a single GUI.

### DETAILED DESCRIPTION OF THE INVENTION

The unified communications platform realized in order to fulfill the objectives of the present invention is illustrated in the attached FIGURE, where:

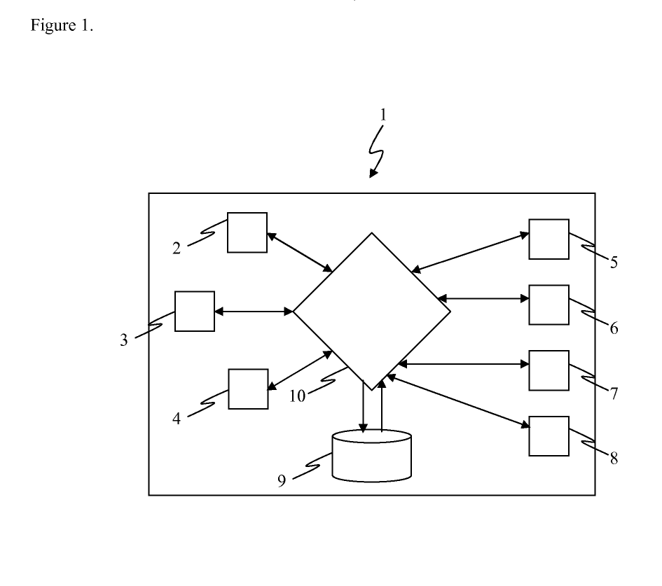

FIG. 1—is the block diagram of the unified communications platform

Elements shown in the FIGURE are numbered as follows:
1. Unified communications platform
2. Telephone adapter
3. Mobile adapter
4. Network adapter
5. WLAN adapter
6. DNS server
7. Mail server
8. Web server
9. VoIP server
10. Storage unit
11. Processing unit

The invention unified communications platform (1) essentially comprises at least one telephone adapter (2) which lets the platform (1) to connect to PSTN networks in order to be able to receive and/or transmit data and/or voice over the PSTN network, at least one mobile adapter (3) which lets the platform (1) to connect to mobile networks in order to be able to receive and/or transmit data and/or voice over the mobile network, at least one network adapter (4) which lets the platform (1) to connect to local area networks and/or wide area networks, at least one WLAN adapter (5) in order for the platform (1) to act as a wireless access point, at least one DNS server (6) which answers domain name queries and is used to host domain names, at least one mail server (7) which lets the users to send and/or receive e-mail messages, at least one web server (8) which lets the users to serve websites, at least one VoIP server (9) which provides a connection point for internet telephony applications such as soft phones, at least one storage unit (10) where the configuration parameters, user files, recordings of calls, web pages, databases and such are stored, at least one processing unit (11) which processes the data and transmits it accordingly.

In the preferred embodiment of the invention, the subject invention comprises at least two network adapters (4) where one network adapter (4) is for connecting to wired networks and the other is for bridging LAN-WAN communication. In this embodiment web server (8) contains interpreters in order to utilize interpreted programming languages such as PHP, Perl, Python, Ruby and such.

In another embodiment of the invention, storage unit (10) contains at least one database where the data such as configuration parameters and user credentials are held. It should be understood that any data that may be stored in the storage unit (10) can also be held in the database where searching for the data according to a query is simplified. The data held in the database is not limited to just configuration parameters and user credentials.

In the preferred embodiment of the invention, subject invention is connected to telephone networks via the telephone adapter (2), to mobile networks (e.g. GSM, UMTS, CDMA, etc.) via mobile adapter (3), wired local and/or wide area networks via network adapter (4), and provides wireless connectivity using the WLAN adapter (5). Even though the network adapter (4) and WLAN adapter (5) provides network connectivity, telephone adapter (2) can be used to get dial-up networking and mobile adapter (3) can be used for receiving data services such as GPRS/EDGE/3G. All of the adapters (2, 3 and 4) can be used to utilize data services, hence providing network connection.

In the preferred embodiment of the invention, DNS server (6) hosts the addresses that are queried, such as name.com or subdomain.name.com. The paths to which the names shall be resolved are set and edited through a graphical user interface (GUI) and are stored in a database.

In the preferred embodiment of the invention, a content management system (CMS) runs on the web server (8). The CMS contains web page templates that are related to names listed in the DNS server (6), GUIs to let the users edit the web pages, configurations and such, personalized areas (such as member areas) to view or edit the user specific options, voice mails, indicators (such as new mail indicator) and such.

In the preferred embodiment of the invention, VoIP server (9) allows connection from both the local area network (LAN) and wide area network (WAN) without the need for setting up a VPN connection. In this embodiment, processing unit (11) analyzes the data packages received from the WAN and processes the packages to be encrypted and/or decrypted. Encryption and decryption of the packages renders the data compromised through a MITM attack useless as the decryption of the data requires proprietary certificates, OTP, passphrases and such. Also, eliminating the need for implementations of point-to-point tunneling protocol such as VPN reduces the hardware costs, maintenance costs and complexity of the system dramatically. As there is no need for a dedicated network for VoIP communications, all servers and services can be utilized using the same network.

In the preferred embodiment of the invention, subject invention is capable of sending and receiving mobile services such as SMS, MMS via mobile adapter (3).

In the preferred embodiment of the invention, subject invention serves as a PBX. Call rules (such as allow/deny long distance, allow/deny international etc.) are defined through the GUI by the system administrator or the user itself. In this embodiment, subject invention is capable of sending and receiving facsimile messages via telephone adapter (2). The received facsimiles may be forwarded to the target user's mail inbox via mail server (7). The received facsimile may also be forwarded to a printer in order to obtain a hard copy. In this embodiment the platform (1) contains a mail-to-fax sub-system which allows the users send facsimiles directly through a personal computer. Facsimiles are transmitted using the platform (1) as a fax server or using traditional fax machines.

In the preferred embodiment of the invention, when a user makes a phone call, processing unit (11) determines the most cost-effective way to the call (such as landline, mobile call or internet call) and processes the call accordingly. In order to define the cheapest way to make the call, processing unit (11) compares the call costs in the database and determines the lowest cost. In this embodiment, soft phones (IP Phones) may also be utilized to make phone calls through landlines, mobile lines and/or VoIP.

In the preferred embodiment of the invention, mail server (7) incorporates anti-virus and anti-spam protections. When an e-mail message is received, these anti-spam and anti-virus layers scan the incoming message in order to detect the threats. The anti-virus and anti-spam libraries used to detect the threats are updated automatically via a signature server.

In the preferred embodiment of the invention, users are able to backup or restore their set of configurations, mails, short messages, call records etc. These backups can be triggered automatically by scheduled tasks (such as cron jobs) or manually through the GUI. The back-ups can be stored in an external drive or can be sent to a remote fileserver via file transfer protocols (such as FTP, SFTP etc.).

Although the present invention has been described and illustrated in detail, it is clearly understood that the same is by way of illustration and example only and is not to be taken by way of limitation, the spirit and scope of the present invention being limited only by the terms of the appended claims.

1. A unified communications platform (1) comprising:
at least one telephone adapter (2) which lets the platform (1) connect to PSTN networks in order to be able to receive and/or transmit data and/or voice over the PSTN network,
at least one mobile adapter (3) which lets the platform (1) connect to mobile networks in order to be able to receive and/or transmit data and/or voice over the mobile network,
at least two network adapters (4) which lets the platform (1) connect to local area networks and/or wide area networks,
one WLAN adapter (5) which lets the platform (1) act as a wireless access point,
at least one DNS server (6) which answers domain name queries,
at least one mail server (7) which lets users send and/or receive e-mail messages,
at least one web server (8) which lets the users serve websites,
at least one VoIP server (9) which provides a connection point for internet telephony applications including soft phones,
at least one storage unit (10) where the configuration parameters, user files, recordings of calls, web pages, databases and such are stored,
at least one processing unit (11) which processes the data and transmits it accordingly and
characterized by a storage unit (10) containing at least one database where the data including configuration parameters and user credentials are held.

2. The unified communications platform (1) as in claim 1 characterized by at least two network adapters (4) where network adapters (4) are for connecting to wired networks to bridge LAN-WAN communication.

3. The unified communications platform (1) as in claim 1, characterized by the web server (8) containing interpreters in order to utilize interpreted programming languages including PHP, Perl, Python, Ruby.

4. The unified communications platform (1) as in claim 1, characterized in that the networking capabilities are also provided by the telephone adapter (2) via dial-up networking and mobile adapter (3) via data services including GPRS.

5. The unified communications platform (1) as in claim 1, characterized in that paths to which names shall be resolved by the DNS server (6) are set and edited through a graphical user interface (GUI) and are stored in the database.

6. The unified communications platform (1) as in claim 1, characterized by the web server (8) running a content management system (CMS) which contains web pages that are related to names listed in the DNS server (6), GUIs to let the users edit the web pages, configurations, personalized areas (including member areas) to view or edit user specific options, voice mails, indicators (including a new mail indicator).

7. The unified communications platform (1) as in claim 1, by the VoIP server (9) which allows connection from both the local area network (LAN) and wide area network (WAN) without the need for setting up a VPN connection.

8. The unified communications platform (1) as in claim 7 characterized by the processing unit (11) which analyzes the data packages received from the WAN and processes the packages to be encrypted and/or decrypted.

9. The unified communications platform (1) as in claim 1, characterized in that it serves as a PBX.

10. The unified communications platform (1) as in claim 9 characterized in that a plurality of call rules (including allow/deny long distance, allow/deny international) are defined through the GUI by the system administrator or the user itself.

11. The unified communications platform (1) as in claim 1, characterized in that it is capable of sending and receiving facsimile messages via telephone adapter (2).

12. The unified communications platform (1) as in claim 11 characterized in that the received facsimiles are forwarded to a target user's mail inbox via mail server (7).

13. The unified communications platform (1) as in claim 1, characterized by the processing unit (11) which determines the cheapest way to make the call (including landline, mobile call or internet call) and processes the call accordingly when a user makes a phone call.

14. The unified communications platform (1) as in claim 1, characterized by the mail server (7) which incorporates anti-virus and anti-spam protections and scans the received e-mail message in order to detect threats.

15. The unified communications platform (1) as in claim 1, characterized in that the users are able to backup or restore their set of configurations, mails, short messages, call records either triggering the backup automatically by scheduled tasks (including cron jobs) or manually through the GUI.

16. The unified communications platform (1) as in claim 1, characterized in that backups are to be stored in an external drive or sent to a remote fileserver via file transfer protocols (including FTP, SFTP).

17. The unified communications platform (1) as in claim 2, characterized by the web server (8) containing interpreters in order to utilize interpreted programming languages including PHP, Perl, Python, Ruby.

18. The unified communications platform (1) as in claim 2, characterized in that the networking capabilities are also provided by the telephone adapter (2) via dial-up networking and mobile adapter (3) via data services including GPRS.

19. The unified communications platform (1) as in claim 2, characterized in that paths to which names shall be resolved by the DNS server (6) are set and edited through a graphical user interface (GUI) and are stored in the database.

20. The unified communications platform (1) as in claim 2, characterized by the web server (8) running a content management system (CMS) which contains web pages that are related to names listed in the DNS server (6), GUIs to let the users edit the web pages, configurations, personalized areas (including member areas) to view or edit user specific options, voice mails, indicators (including a new mail indicator).
